(19) United States
(12) Patent Application Publication
(10) Pub. No.: US 2006/0034478 A1
(43) Pub. Date: Feb. 16, 2006

(54) Audio eyeglasses

(76) Inventor: Kevin E. Davenport, Florham Park, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 10/915,104

(22) Filed: Aug. 11, 2004

(51) Int. Cl. H04R 25/00

(52) U.S. Cl. 381/381; 381/327

(57) ABSTRACT

Audio eyeglasses comprise: a frame assembly having left and right temples and a front; a lens assembly secured to the frame assembly; and an audio unit disposed in the frame assembly. The audio unit comprises: (i) mass storage means for storing a plurality of digital audio files and selectively outputting at least one of said digital audio files; (ii) a playback unit adapted to receive said at least one digital audio file from said mass storage means and convert it to an electrical audio output signal; and (iii) control means for enabling said user to select said at least one audio file for output and control the playback thereof by said playback unit. At least one, and preferably two, audio transducers are attached to the frame assembly and proximate an ear of the user. The transducers are operably connected to the audio unit to receive the electrical audio output signal and convert it to a sound wave transmitted to the user's ears. Further provided is a personal audio system incorporating the audio eyeglasses and a docking station adapted to receive the eyeglasses and be connected to a computer for download of digital audio files.

### BACKGROUND OF THE INVENTION

1. Field of the Invention

The present invention relates to a personal audio player; and more particularly, to a pair of wearable eyeglasses having integrated therein a system, such as an MP3 player, for storing and selectively playing audio program content.

2. Description of the Prior Art

Advances in the technology for the storage and reproduction of data in digital form have spurred the development of a variety of portable audio players. While receivers capable of receiving broadcast audio program content that are small and light enough to be truly portable have been available for some time, audio devices on which a user could record and selectively play back audio content have only become available more recently. Because of the very nature of broadcasting, a user of a radio receiver has only limited choice of the program content received. Ordinarily the user's control is limited to the selection of a specific station. Although stations typically adopt a particular broadcasting format, which includes a preference for music or other programming having a characteristic style or emphasis, the listener has no freedom to select particular songs, placing a definite limitation on the entertainment value and pleasure derived from listening to broadcast stations. In some geographical areas, the number of stations that can be satisfactorily received may be limited. A station conforming to the listener's preference may be simply unavailable. Even in areas served by numerous broadcast stations, reception quality is frequently impaired, e.g. in the interior of buildings constructed with large amounts of steel.

The inherent limitations of broadcasting as a content source have spurred the development of portable audio players over which a user has more programmatic control. One such player that has been available for a number of years is the Sony Walkman™, which is capable of reproducing content magnetically recorded in analog mode on a conventional cassette tape. As typically sold, the Walkman unit includes a housing containing a mechanical system for moving the tape past a magnetic read head, control buttons that activate and control the mechanical system, electronics for converting the signals derived from the tape into a form suitable for output, and a battery power source. The housing also provides an electrical jack by which headphones for the playback are connected.

Comparable units are also available commercially for playing back audio content stored on a compact disk (CD). This recording medium stores data digitally, as a series of pits or other features that differentially reflect light. The CD is read by impinging a laser light onto the surface of the rotating disk and detecting the intensity of reflected light, which is modulated by differences in reflectivity of locations with or without the pits or comparable features. The reflected intensity provides a digital electrical signal that is subsequently converted into an analog signal to drive headphones or speakers which produce audible sound waves. In both cassette- and CD-based players, the housing has a physical size that is constrained to be at least somewhat larger than the size of the bare recording medium. The physical dimensions, recording format, and storage limits for CDs and audiocassette tapes are set by industry standards.

More recently, various audio players employing other forms of data storage, including players that are smaller in size but provide greater storage capacity have also become available, such as the Apple iPod™. The audio program content in many of these players is digitally stored in a compressed format known as the MPEG-1, Level 3 format, commonly abbreviated as MP3. Audio players wherein data are stored in the MP3 compressed format are often referred to simply as MP3 players.

The aforementioned radio receivers and audio players employ one or more audio transducers of some form that convert electronic signals corresponding to the desired audio content into actual sound waves that are heard by the user. Frequently, the transducers are in the form of headphones, which comprise two miniature audio speakers joined by a compliant headband appointed to traverse the user's head and support the speakers proximate the user's ears. Also known are headset systems employing one or two individual speakers that are mechanically supported by one or both of the user's external ears (e.g. with clips or other support members) and earbuds, which are tiny speakers inserted into the user's external ear held in place by friction.

A basic description of the well-known external anatomy of the human ear is helpful for understanding the present invention. Referring to FIG. 1, there is shown a depiction of the human ear E. The external ear consists of an expanded portion of cartilage called the pinna or auricle 2, which is of a generally ovoid form. The ear canal C opens within the bowl or concha 4, which is a capacious cavity formed within the pinna. The concha is partially spanned by opposing protrusions, the tragus 6 and the antitragus 8, separated by a wide notch. Sound waves impinging on the ear travel through the ear canal to strike the eardrum (not shown). Vibrations thus induced in the eardrum are perceived by the hearer as sounds, as is well known.

In most known receivers and media players, the aforementioned audio transducers are used in conjunction with a separate housing for the electronic portion of the apparatus, which may be held in the user's hand, placed in a pocket or otherwise secured to a garment, or suspended from a lanyard or strap worn around the neck, shoulder, wrist, or other portion of the user's body. The transducers electrically communicate with components in the housing through an electrical cord, which carries an electrical signal to drive the headphones, usually stereophonically. Commonly, the cord is terminated at one end with an electrical plug appointed to be received in a complementary jack or receptacle in the appliance housing, whereby a connection is removably established. Significant shortcomings result from the requirement of such a cord, relating to cost, reliability, convenience, and safety. Users often experience the frustration of cords that break and connections that become intermittent or unreliable after use. Moreover, audio players are frequently used by persons engaged in other forms of everyday activity, including those that involve significant bodily movement, in the course of either work or play. Headphone cords are often considered to be a significant impediment, because they become tangled and sometimes encumber the person's motion while doing physical labor, exercising, or enjoying various recreational activities, such as walking, running, biking, using exercise machinery, playing individual or team sports, or the like). The user's perspiration is likely to find its way onto cord connectors and even into the electronic device housing itself, leading to corrosion that degrades or severs the connection. At best, the cord is a nuisance. In some instances, the cord even presents a safety hazard; since it can become entangled in machinery, exercise equipment, or the like.

A number of commercially available headset assemblies provide a radio receiver that is mounted within a resilient headband, which terminates at a pair of end mounted speakers that are adapted to be placed over the user's ears. Although these assemblies do not require a separate electronics housing and cord connection, in most cases the assemblies are relatively heavy. The earphones in known devices frequently are rather large and cumbersome. When worn for an extended time, they become uncomfortable, result in perspiration, and minimize the flexibility of use by individuals who may require or prefer to use sunglasses or corrective eyewear with the headset.

Accordingly, there remains a significant need in the art for audio players that overcome the foregoing limitations and are compatible with wearing eyeglasses. Also desired are players that are smaller, lighter, more comfortably worn, equipped with greater storage capacity, and more conveniently controlled and programmed with musical selections or other audio program content of a listener's choice.

### SUMMARY OF THE INVENTION

The present invention provides in one aspect a personal audio player having the form of audio eyeglasses adapted to be worn by a user. The eyeglasses comprise: a frame assembly having left and right temples and a front; a lens assembly secured to the frame assembly; and an audio unit disposed in the frame assembly. The audio unit comprises: (i) mass storage means for storing a plurality of digital audio files and selectively outputting at least one of the digital audio files; (ii) a playback unit adapted to receive the at least one digital audio file from the mass storage means and convert it to an electrical audio output signal; and (iii) control means for enabling the user to select the at least one audio file for output and control the playback thereof by the playback unit. The audio unit is adapted to be connected to an electrical power source disposed in the frame assembly. At least one audio transducer is attached to the frame assembly and proximate an ear of the user. The transducer is operably connected to the audio unit and is adapted to receive the electrical audio output signal and convert it to a sound wave transmitted to the user's ear. Preferably, the audio eyeglasses incorporate a transducer for each of the user's ears and the audio reproduction is accomplished stereophonically.

In another aspect, there is further provided a personal audio system comprising the aforementioned audio eyeglasses and a docking station. The eyeglasses and docking station have mating audio system and computer docking connectors that are adapted to mate to establish a data connection.

It is also preferred that the eyeglasses include interface means for connecting the eyeglasses to a data source, such as a personal computer, having digital audio source files. The interface means permits such source files to be transferred and stored in the mass storage means.

The present eyeglasses are conveniently worn by a user, who may carry out a variety of other activities while simultaneously experiencing the enjoyment of listening to music or other audio program content. The user is afforded great flexibility and individuality in the choice of musical selections. The incorporation of the sound reproduction means in the eyeglasses leaves the user unencumbered by long cords, separate electronics modules, and uncomfortable headsets used in many prior art audio devices. The present eyeglasses are light in weight, comfortably worn, equipped with large storage capacity, and easily programmed and operated.

### BRIEF DESCRIPTION OF THE DRAWINGS

The invention will be more fully understood and further advantages will become apparent when reference is had to the following detailed description of the preferred embodiments of the invention and the accompanying drawings, wherein like reference numeral denote similar elements throughout the several views and in which:

FIG. 1 is a perspective view of a human ear;

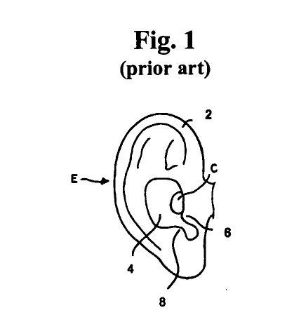

FIGS. 2A and 2B are left and right perspective views, respectively, of audio eyeglasses in accordance with the invention;

FIG. 3 is a perspective view of another audio eyeglasses in accordance with the invention;

FIG. 4 depicts a schematic block diagram of a portion of a personal audio system in accordance with the invention;

FIG. 5 depicts a schematic block diagram of a portion of another personal audio system in accordance with the invention;

FIG. 6 is a perspective view of another audio eyeglasses in accordance with the invention; and

FIG. 7 is a perspective view of yet another audio eyeglasses in accordance with the invention.

### DESCRIPTION OF THE PREFERRED EMBODIMENTS

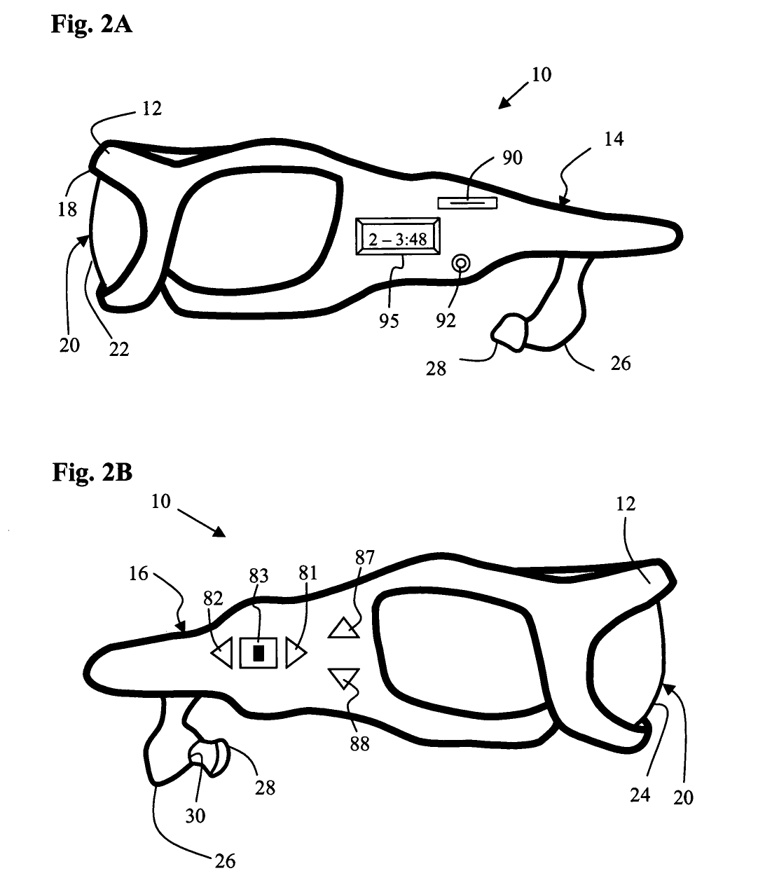

Referring to FIGS. 2A-2B, there is depicted a personal audio system in the form of audio eyeglasses 10 appointed to be worn by a user. The glasses 10 include an ophthalmic frame having a form that includes a front 12, and left and right temples 14, 16 depending from ends of the front. Front 12 traverses the width of the wearer's face. An indentation or bridge 18 allows the front to engage the wearer's nose and be comfortably supported thereby. Some embodiments, including that seen in FIGS. 2A-2B, employ a frame in which front 12 and temples 14, 16 are formed as a molded, unitary assembly. In other embodiments, temples 14, 16 are hingedly connected to front 12. In the embodiment shown in FIGS. 2A-2B, each temple is shaped to pass between the pinna and a side of the user's head and be supported on the pinna. It will be understood that in some embodiments, the temples optionally may press on the temporal areas of the sides of the user's head, thereby providing frictional support. The frame is composed of one or more of metal, plastic, or other polymeric material.

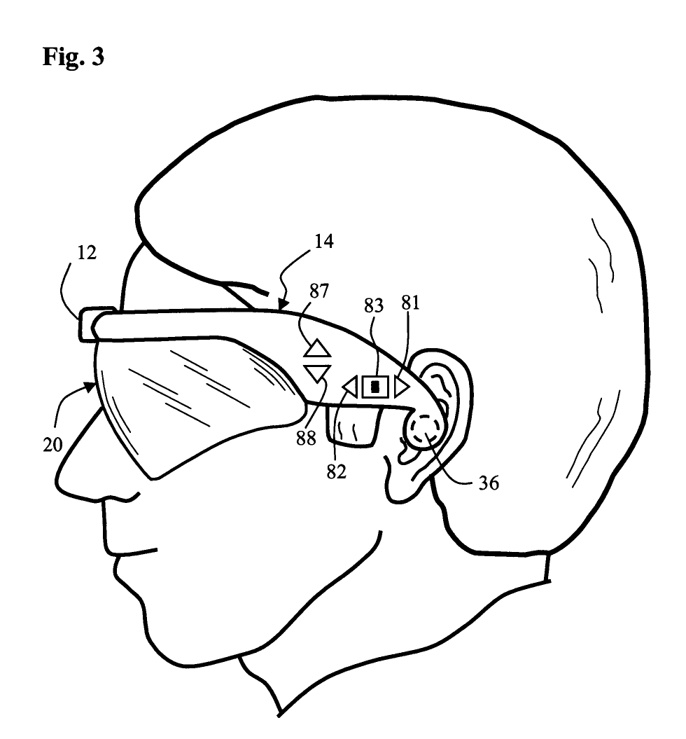

Eyeglasses 10 further comprise a lens assembly 20 that includes lenses 22, 24 disposed in front of the wearer's eyes. The lenses may be discrete optical elements supported by support means, such as wires, encircling metal or plastic, one or more small holes in the lenses accommodating fasteners, or the like. In other implementations the lens assembly is in a molded, unitary form incorporating respective optical structures for the two eyes. One such lens assembly configuration is a wraparound type, as depicted in FIG. 3. The lenses in the present eyeglasses may be of any of the types used to compensate for a user's refractive error, or they may be optically neutral lenses, also known as plano lenses. Additionally, the lens assembly or lenses may be substantially transparent to visible light, or the lenses or assembly may be tinted, metallized, or otherwise coated or treated so that the assembly filters or reduces the transmission of visible, ultraviolet, or infrared light therethrough. For example, glasses incorporating lenses or a full lens assembly thus treated may be used as sunglasses. Suitably chosen coating or treatment also permits glasses in certain embodiments to be used for protecting the eyes, e.g. against occupational exposure to flying debris or untoward light sources, such as might be encountered during welding or operation of lasers. In some embodiments the lens assembly is an easily removed part of the eyeglasses. For example, such a configuration permits a substantially clear assembly to be exchanged for a tinted assembly, thereby converting the eyeglasses into sunglasses. Preferably the lenses or lens assembly are made of impact-resistant plastic, such as polycarbonate, although optical glass or other plastics may also be used.

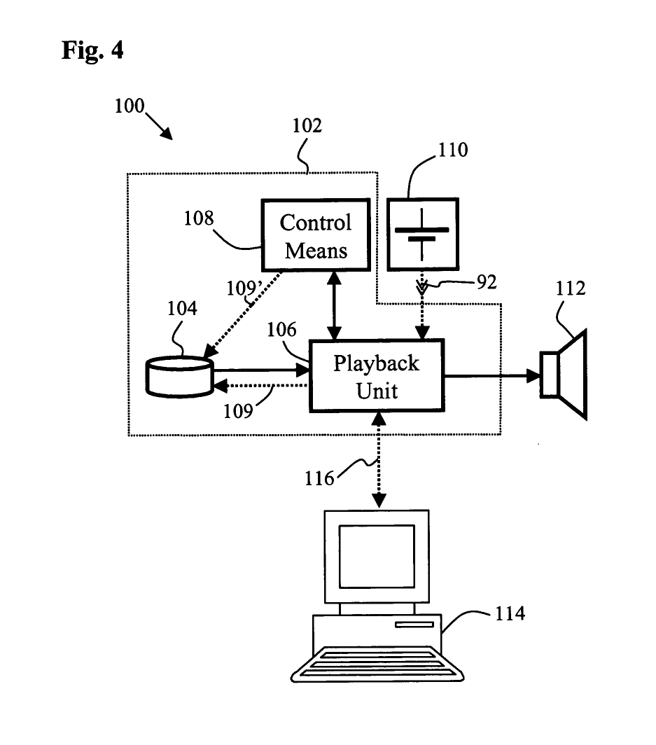

The present eyeglasses further include a personal audio system for storing and playing back audio program content for the user's benefit and enjoyment. Referring additionally to FIG. 4, there is shown generally at 100 a block diagram of a portion of an embodiment of a personal audio system of the invention. Audio unit 102 comprises mass storage means 104, playback unit 106, and control means 108. The electronic components of the audio system are adapted to be energized by an electrical power source, such as replaceable or rechargeable battery 110. Mass storage means 104 digitally stores audio program content as a plurality of digital audio files. Such files may comprise any of songs, musical selections, readings, drama productions, educational material, or any other desired audio content. Mass storage means 104 is adapted to output one or more of the files to playback unit 106, as directed by user input effected through control means 108, which is connected either directly 109′ to mass storage means 104 or indirectly 109 through playback unit 106. Playback unit 106 accepts digital files outputted from mass storage means 104 and converts them to analog electrical signals that correspond to the stored audio files. Playback unit 106 incorporates known electronic components, such as discrete or integrated semiconductor elements, resistors, capacitors, inductors, filters, and the like, to accomplish its digital and analog electronic functions in a known manner. Read-only memory (ROM) and random access memory (RAM) are preferably included in playback unit 106. In addition, it will be understood that the processing functions required for the operation of the present audio eyeglasses may be apportioned in different ways among the various system components in different embodiments. The electrical signals are then input to audio transducer 112, which may comprise one or more speakers or earphones of any known type. Transducer 112 converts the electrical signals to sound waves which impinge on one or both of the user's ears.

In a preferred embodiment, control means 108 comprises a plurality of buttons that control the operation of the audio player. The controls available effect one or more of: turning the unit on/off, the selection of the one or more files to be output, playback volume, and audio characteristics such as tone and balance between two transducers that provide sound stereophonically to a user's two ears, and other functions commonly associated with audio players. Examples of such control buttons are shown in FIGS. 2A and 2B, including volume control buttons 87 and 88 that raise and lower the playback volume, forward and reverse buttons 81, 82, and stop button 83. Alternatively, one or more multi-function buttons, e.g. buttons actuated by movement in different directions to trigger different functions, can replace a plurality of individual buttons. Rotary controls may also be used for any of the control functions of the present device. In addition, control means 108 optionally further comprises an alphanumeric display, such as a liquid crystal display 95, that indicates one or more of the time and date, battery charge status, a title or code (such as a file number) indicative of the file or files selected for playback, the time length of a selection, the elapsed or remaining time during the playback of a selection, or other desirable information related to the operation of audio unit 102.

Audio unit 102 further includes means by which digital files representative of audio program content may be loaded into mass storage means 104. Preferably, interface means 116 is used to connect audio unit 102 to a source of such files, such as a conventional general-purpose computer. In the embodiment depicted, a conventional personal computer (PC) 114 is connected by interface means 116.

Interface means 116 may comprise any known protocol (and associated hardware and software) used to interconnect digital electronic appliances. Both wired and wireless forms of connection for the transfer of data are suitable. Wireless connections may employ electromagnetic radiation of any wavelength, including radio, microwave, and light of visible and non-visible (e.g., infrared) wavelengths. Interface means 116 permits audio content, e.g. digital audio data files stored on PC 114, to be transferred and stored in mass storage means 104. The files can then be played back at any subsequent time under the user's control. Suitable audio data files can be obtained from many sources. Pre-recorded files, e.g. files digitally stored on commercially disseminated recordings, such as CDs or DVDs, may be read by suitable drives associated with the PC and intermediately stored in mass storage devices in the PC or transferred directly to the present eyeglasses. Digital files may also be obtained from other users or downloaded from Internet-based repositories. Any of these files may be transferred to the user's device. In addition, PC's frequently include interfaces and software permitting analog audio program sources, e.g. broadcast receivers, tape recorders, and microphone output from live sources, to be digitized and converted to stored files, which also may be transferred to the present eyeglasses. The availability of program content from these diverse sources affords a user of the present system wide discretion and selection of desired audio program content, including music. The files may be accessed for playback in any desired order.

In some embodiments of the invention, interface means 116 comprises a wired data connection. A universal serial bus (USB) connection is one preferred form of wired interface connection. Details concerning the USB standard are known in the art, e.g. by reference to http://developer.apple.com/hardware/usb/. A conventional USB cable includes conductors that enable bi-directional data communication. In addition, other conductors in a USB cable enable electrical power to be transferred from a host device to a connected device. In the present instance, electrical power derived from a host device through a USB cable is optionally used to power the eyeglasses for operation or to recharge a battery therein.

Other known wired interfaces may also be used, including connections in accordance with the IEEE 1394 standard (also known as FireWire, published by the Institute of Electrical and Electronics Engineers, and incorporated herein in the entirety by reference thereto) and the older RS232 and Centronics (parallel) interfaces. Some interfaces also permit the transfer of electrical power, as set forth hereinabove in connection with the USB interface. Furthermore, the present eyeglasses may be equipped with a modem for communications with a remote system by telephone or cable or via a wireless cellular telephone connection. Implementations using any of the wired forms of interface require the presence of a suitable connector in the eyeglasses, such as USB connector 90, to which a cable 118 of the requisite type is attachable to connect the glasses and the host device.

Interface means 116 may also comprise wireless connections suitable for high-speed data interchange. One such protocol is specified by IEEE Standard No. 802.11, published by the Institute of Electrical and Electronics Engineers, and incorporated herein in the entirety by reference thereto. Standards in the IEEE 802.11 class (which are also known commonly as “Wi-Fi”) specify a local area network system for wirelessly connecting individual electronic devices such as the present audio eyeglasses to a local server through which the devices may communicate wirelessly, e.g. through a local intranet or the global Internet. Other wireless protocols that may be used to establish bi-directional connectivity are also known, such as the Bluetooth Standard, published by the Bluetooth SIG and available through the website www.bluetooth.com, and incorporated herein in the entirety by reference thereto. Alternatively, wireless bi-directional communication may be implemented optically, e.g. in conformance to the known IrDA standard for infrared communication. Additional details and technical specifications for the IrDA standard are available through the website www.irda.org.

Communication in accordance with any of the foregoing wireless protocols requires the provision of a suitable transmitter and receiver and an associated antenna in the eyeglasses and a complementary system associated with the host device, as would be understood by one skilled in the computer interfacing art.

Mass storage means 104 may comprise any system capable of reading, and addressably and reversibly storing, substantial amounts of digital data. Known systems suitable for the present audio unit include solid-state memories based on semiconductor, ferroelectric, or magnetic phenomena, and magnetic, magneto-optical, or optical disk drives. Preferably, mass storage means 104 is capable of reading and writing at least about 32 megabytes (MB) of data. More preferably, at least about 1 gigabyte (GB), and, most preferably, at least about 5 GB or more of data are stored. Among the preferred storage systems are miniaturized disk drives, such as those available commercially as the Microdrive sold by Hitachi Global Storage Technologies, Inc. and the Cornice Storage Element sold by Cornice Inc., and flash memory devices. Presently known miniaturized disk drives have maximal lateral dimensions as small as about one inch and are capable of storing 1-2 GB or more. It is also preferred that mass storage devices used in the present eyeglasses include capability for both reading and writing. Mass storage devices or media used therewith (such as disks and flash card memory) are optionally removable. Removable, writable media advantageously may be connected to another device, e.g. a PC, and pre-loaded with pre-selected audio data files, and thereafter connected to the present audio eyeglasses. Preferably, data is organized in the mass storage means in data files, each being uniquely addressable for reading and writing. It will be understood that mass storage means 104 may comprise the storage media itself, along with the requisite circuitry to control the reading and writing of the media and to suitably process input and output data in proper digital electronic form for use by other parts of the player.

As is known in the art, a sound wave can be represented digitally as a sequence of bits corresponding to the instantaneous pressure amplitude of the sound wave over a time period. Such a representation can be captured by converting an analog electrical signal representing the sound wave into digital form using known analog to digital electronic conversion circuitry. Uncompressed data are obtained by digitizing the electrical signal at a preselected digitizing rate with a preselected bit resolution and storing the result. A sufficiently high digitizing rate and resolution permits the signal to be recorded and subsequently reproduced with a fidelity that cannot readily be distinguished from the original sound by a human listener. For example, CDs are ordinarily recorded stereophonically, each channel being digitized at a rate of about 44.1 kHz and with 16 bits of resolution. This rate satisfies the Nyquist criterion for frequencies up to about 22.05 kHz, and the 16 bits provide an effective dynamic range of over 90 dB. During CD playback, the uncompressed, stored data are read back as a string of bits and reconverted to an analog electrical signal by known digital to analog converter circuits. The resulting signal is suitably amplified and processed to drive the sound transducers. CDs provide a sound quality and fidelity that are considered ample by most listeners.

However, in order to reduce the amount of digital data that must be stored for an audio selection of a given duration, the present eyeglasses preferably employ a compressed data format instead of the uncompressed format used in present CDs. One suitable compression format is the protocol promulgated by the Moving Picture Experts Group as the MPEG-1, Level 3 standard, generally known as the MP3 standard. MP3 compression employs psycho-acoustic models of human audio perception and permits file size to be reduced by a factor of 7-10 or more without appreciable loss of sound fidelity as perceived by most listeners. Other compression protocols may also be used to store audio files in the present eyeglasses.

Audio data stored in MP3 or other compressed format are read back and decompressed by suitable decompression circuitry as known in the digital recording art. Preferably the circuitry employs dedicated digital signal processing chips. The decompressed digital data are then converted to an analog electrical signal by known digital to analog converter circuits. The analog signal is fed to an amplifier that produces a signal suitable to drive the sound transducers of the present eyeglasses.

The frame of the present eyeglasses houses the audio unit and the controls associated therewith. The components of the audio unit and the battery are preferably disposed in one or more cavities located in the temples. The frame also includes any one or more connectors required for a wired connection to a host computer for uploading audio data files, along with buttons or other devices associated with the control means. Preferably the buttons and connectors are disposed in the temples. Certain embodiments include removable batteries or mass storage means which are preferably disposed in cavities accessible through one of the exterior surfaces of the temples. These cavities are optionally closed by openable or removable covers. Also optionally present at the surface of the frame are solar cells used to operate the audio unit or recharge the battery. The frame further preferably includes connector 92 that accepts input of electrical power from a power supply, such as an external battery, or a power converter or battery charger energized by household electricity, an automobile electrical system, or the like.

Conductors used to interconnect the elements of the present audio system may be provided as etched traces on printed circuit boards, or as wires or conductors routed through grooves or channels in the frame of the eyeglasses. Implementations having hinged temples may include flexible wires traversing the hinged joints. Alternatively, connector pins are disposed in facing relationship in the temple and front, such that electrical connection is established by opening the hinge into its normal configuration for wearing the glasses. The preferred configuration of the glasses substantially balances the weight of the components in each of the temples, to provide maximum comfort for the user, especially during extended wear. The temples are preferably vertically widened, as depicted in the figures herein, to accommodate the elements of the present audio system.

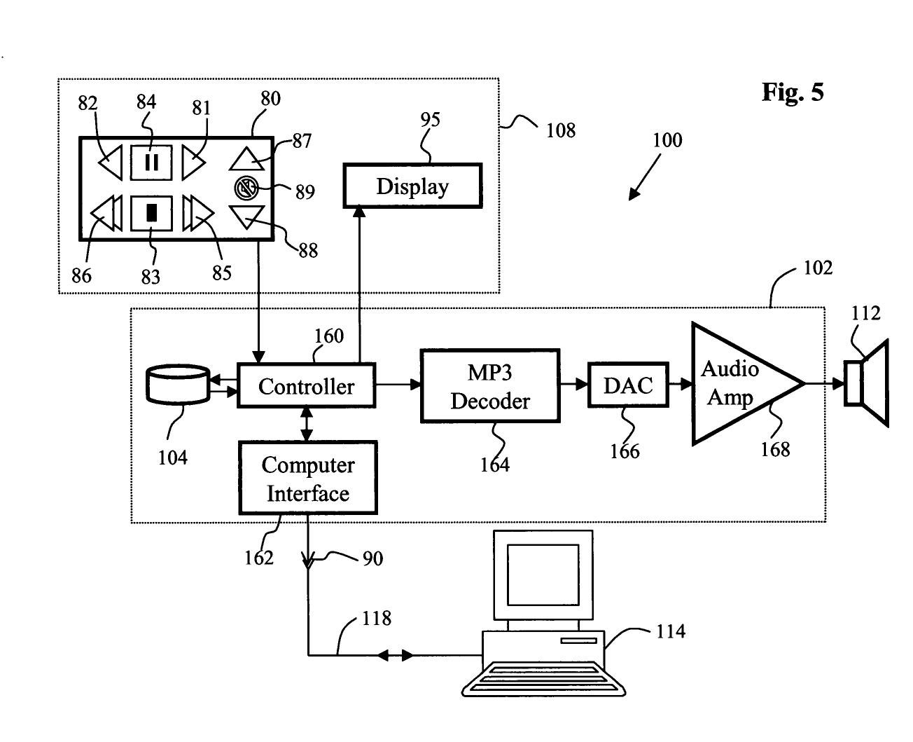

An implementation of an MP3 audio system 100 is further depicted by FIG. 5. Digital audio data files are stored by mass storage means 104. Control means 108, comprising various controls and an alphanumeric display 95, communicates with controller 160. As shown, control means 108 includes buttons for choosing and controlling musical selections, such as forward 81 and reverse 82 buttons, pause button 84, stop button 83, and track advance 85 and track back 86. Volume is controlled by up 87 and down 88 buttons and mute 89. Selections and player function chosen using the various controls cause controller 160 to operate mass storage means 104 and computer interface 162. Digital playback from mass storage means 104 is fed to MP3 decoder 164, which decompresses the outputted digital data to produce uncompressed digital data. Digital to analog converter circuitry 166 of any suitable type converts the uncompressed digital signal to an analog electrical signal for amplification by amplifier 168 and output by audio transducer 112. It will be understood that two-channel operation is preferred to produce stereophonic sound, each channel feeding a transducer for one of the user's ears.

The present audio eyeglasses include one or more transducers disposed in the temples and proximate an ear of the user. In a preferred implementation, a transducer is present in each temple to deliver sound to the user's ears stereophonically. An earpiece attached to each temple engages the respective ear at a location proximate the entrance to the ear canal. The earpieces each include an opening or channel for the transmission of sound. The embodiment depicted by FIGS. 2A-2B includes earpiece supports 26 that are rigidly attached to the respective sides of the frame near the distal end of each temple. Earpiece insert portions 28, which are preferably composed of foam or other resilient material, are received in the conchas 7 of the user's ears proximate the opening of the ear canal. Earpiece insert portion 28 is connected to support 26. Supports 26 and earpiece insert portions 28 may have a centrally located channel through which sound waves propagate from miniature speakers (not shown) inside the temples or earpiece supports 26 to an opening at the end of the portion, and thereafter into the user's ear canal. The transducers may also be housed directly in insert portions 28.

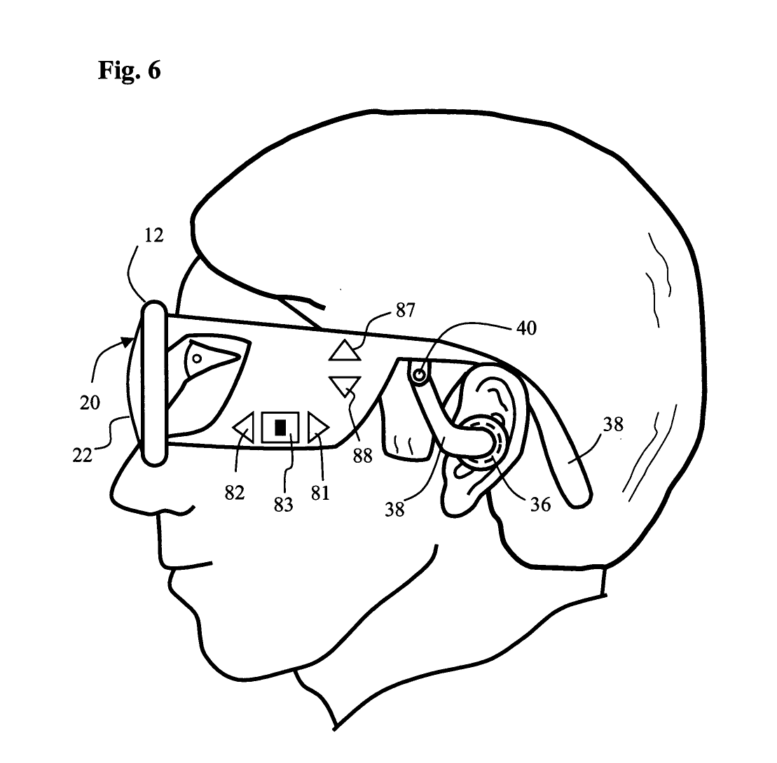

While in some embodiments supports 26 and earpiece insert portions 28 are rigidly molded as part of the frame (see, e.g. FIG. 3), it is preferred that adjustment means be provided to permit a comfortable engagement of the earpieces in a user's ears. Adjustability afforded thereby allows the present eyeglasses to accommodate the normal variations in the size, shape, and location of different users' ears. The adjustment means may include provision for angular adjustment of the earpieces about a single pivot point or in multiple angular directions. For example, the embodiment of FIGS. 2A and 2B includes a multiply flexible joint, such as a ball and socket arrangement 30, connecting support 26 and earpiece insert portion 28. In the embodiment of FIG. 6, miniature speakers 36 are situated on support members 38 that depend from temples 14, 16 and are angularly adjustable, e.g. in one axis of angular motion about a pivot point 40. Support members 38 are optionally spring-biased to urge speakers 36 against the user's ears. Elements of the earpieces, such as the earpiece insert portions, may also be telescopically slidable to adjust their length (not shown). The support member may also be flexible or be adapted to be bent to a desired orientation. In some embodiments, eyeglasses 10 are customized for a particular user by custom molding at least a portion of the earpieces, such as earpiece portions 28, to a shape that replicates the shape of that user's external ears.

FIG. 6 further depicts a form of temples 14, 16 used in some embodiments, further comprising temple end portions 38 that extend downwardly and behind the pinnas to better secure the eyeglasses in the appointed position. The end portions 38 may be integrally molded with the rest of the temple or formed as a separate rigid or flexible wire-like portion, or fashioned in any other suitable form that provides suitable support and engagement with the user's ears.

In still other embodiments of the eyeglasses (not shown), each temple includes transducers and flexible tubes depending from the temples and adapted to conduct sound from the transducer to the user's ears. Each tube is connected at one end to the temple to receive the sound. The other end terminates in an earpiece insert portion adapted to be inserted into the opening of the user's ear canal for delivery of the sound.

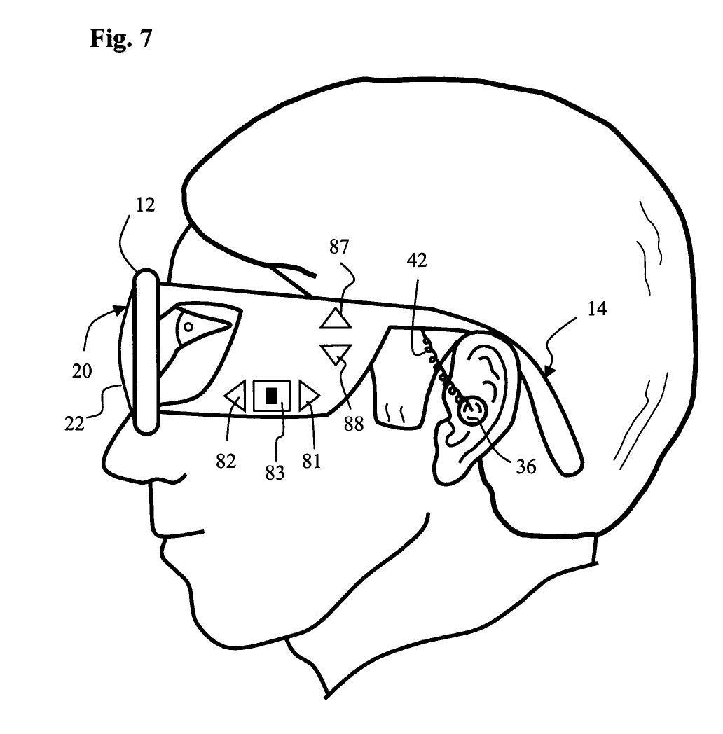

Yet another embodiment of the eyeglasses employs miniature speakers (also known as earbuds) electrically connected to the temples by short flexible cords 42, as depicted by FIG. 7. Preferably, each of the temples in this embodiment has a cavity (not shown) for stowage of the respective speaker when the glasses are not is use. A user dons the glasses for use by removing the speakers from their storage cavities, placing the glasses in the accustomed position, and inserting the speakers in his/her respective ears. Although the cords may be generally straight, they preferably are helically coiled and elastically extensible, as shown in FIG. 7. In another embodiment (not shown), the cords retractably extend from the frame and are secured in the extended position during use by an escapement mechanism, but are urged to retract otherwise by spring means.

In still another aspect, there is provided a system that includes a docking station. An embodiment of this aspect comprises audio eyeglasses and a docking station, having complementary, electrical docking connectors. The docking station is further adapted to be connected to a host computer. The docking connectors provide for the bi-directional interchange of digital data and optionally, electrical power and analog audio signals. The use of a docking station permits a bi-directional digital connection for file transfer between the computer and eyeglasses to be established simply and conveniently. In addition, electrical power to operate the glasses and charge a battery therein is preferably supplied through the connectors. Connection of analog audio lines permits audio files output by the eyeglasses to be received and audibly played, either through speakers or headphones connected to the computer or by externally situated speakers, headphones, or a powered sound system. The docking station may also be connected separately to an external source of electrical power, such as a line charger, for transferring electrical power to operate the eyeglasses or recharge batteries therein.

In some embodiments, the audio unit and power source are disposed in a module that is detachable from the frame assembly. The module and the frame assembly in these embodiments include mating connectors to electrically connect the module to the components located in the frame. Preferably a cavity present in the frame is adapted to receive the removable module, and a mechanical catch or cover secures the module. The removable electronics module is adapted to be operated either mounted in the eyeglasses or as an independent unit. Audio output from the module when operated independently can be played through separate speakers, headphones, or a powered sound system that may be connected directly to the module. The removable module preferably includes interface means permitting loading of audio data files, as described hereinabove.

Embodiments including removable electronics module preferably also include a docking station adapted to receive the module and be connected thereto. The docking station is also adapted to be connected to a host computer. As described hereinabove, such a docking station permits loading of audio files from the computer into the device's mass storage, the supply of electrical energy, and the transfer of audio signals to externally situated speakers, headphones, or a powered sound system.

Having thus described the invention in rather full detail, it will be understood that such detail need not be strictly adhered to, but that additional changes and modifications may suggest themselves to one skilled in the art, all falling within the scope of the invention as defined by the subjoined claims.

1. Audio eyeglasses adapted to be worn by a user, said eyeglasses comprising:
(a) a frame assembly having left and right temples and a front;
(b) a lens assembly secured to said frame assembly;
(c) an audio unit disposed in said frame assembly and comprising:
(i) mass storage means for storing a plurality of digital audio files and selectively outputting at least one of said digital audio files, comprising at least one disk drive selected from the group consisting of magnetic, magnetooptical, and optical disk drives;
(ii) a playback unit adapted to receive said at least one digital audio file from said mass storage means and convert it to an electrical audio output signal;
(iii) control means for enabling said user to select said at least one audio file for output, and to control the playback thereof by said playback unit; and
(iv) interface means for connecting said eyeglasses to a data source having digital audio source files and transferring said digital audio source files to said mass storage means;
said audio unit being adapted to be connected to an electrical power source disposed in said frame assembly; and
(d) at least one audio transducer proximate each ear of said user, said transducers being attached to said frame assembly and operably connected to said audio unit and adapted to receive said electrical audio output signal and convert it to a sound wave transmitted to said ear of said user.

2. (canceled)

3. Audio eyeglasses as recited by claim 1, wherein said interface means comprises a wired interface connection and an interface connector.

4. Audio eyeglasses as recited by claim 1, wherein said wired interface connection is selected from the group consisting of USB and IEEE 1394 connections.

5. Audio eyeglasses as recited by claim 1, wherein said interface means comprises a wireless interface connection.

6. (canceled)

7. Audio eyeglasses as recited by claim 6, comprising an earpiece in each of said right and left temples.

8. Audio eyeglasses as recited by claim 7, wherein said earpieces are rigidly attached to said temples.

9. Audio eyeglasses as recited by claim 7, wherein said earpieces further comprise adjustment means.

10. Audio eyeglasses as recited by claim 9, wherein said adjustment means comprises a joint about which at least a portion of said earpieces are adapted to rotate in at least one angular direction.

11. Audio eyeglasses as recited by claim 10, wherein said adjustment means comprises a ball and socket arrangement.

12. Audio eyeglasses as recited by claim 9, further comprising flexible cords secured to said earpieces and said temples and electrically connecting said earpieces to said audio unit.

13. Audio eyeglasses as recited by claim 1, wherein said audio unit is housed in a module detachable from said frame assembly.

14-15. (canceled)

16. Audio eyeglasses as recited by claim 1, wherein said mass storage means comprises a magnetic disk drive.

17. Audio eyeglasses as recited by claim 1, wherein said mass storage means further comprises flash memory.

18. Audio eyeglasses as recited by claim 1, wherein said mass storage means comprises a removable storage element.

19. Audio eyeglasses as recited by claim 1, further comprising at least one solar cell disposed at the surface of said frame assembly and connected to said audio unit.

20. Audio eyeglasses as recited by claim 1, wherein said electrical power source comprises a rechargeable battery disposed in said frame assembly.

21. Audio eyeglasses as recited by claim 3, wherein said electrical power source comprises a rechargeable battery disposed in said frame assembly and electrical power for recharging said battery is provided through said interface connection.

22. A personal audio system, comprising:
(a) audio eyeglasses as recited by claim 1 and further comprising an audio system docking connector;
(b) a docking station having a computer docking connector adapted to mate with said audio system docking connector, said docking station being adapted to be connected to said data source; and
(c) said interface means comprises a connection to said data source established through said audio system and computer docking connectors.

23. A personal audio system as recited by claim 22, wherein said electrical power source comprises a rechargeable battery disposed in said frame assembly, and electrical power for recharging said battery is provided through said docking station.

24. A personal audio system as recited by claim 23, wherein said electrical power is provided by a power converter or battery charger connected to said docking station.

25. A personal audio system as recited by claim 23, wherein said electrical power is derived from said data source.

26. A personal audio system as recited by claim 22, wherein said audio unit is housed in a module detachable from said frame assembly and said audio system docking connector is located in said detachable module.

27. Audio eyeglasses adapted to be worn by a user, said eyeglasses comprising:
(a) a frame assembly having left and right temples and a front, earpieces rigidly attached to each of said right and left temples, and an earpiece insert portion attached to each of said earpieces and adapted to be received in a concha of said user's ear;
(b) a lens assembly secured to said frame assembly;
(c) an audio unit disposed in said frame assembly and comprising:
(i) mass storage means for storing a plurality of digital audio files and selectively outputting at least one of said digital audio files;
(ii) a playback unit adapted to receive said at least one digital audio file from said mass storage means and convert it to an electrical audio output signal;
(iii) control means for enabling said user to select said at least one audio file for output, and to control the playback thereof by said playback unit; and
(iv) interface means for connecting said eyeglasses to a data source having digital audio source files and transferring said digital audio source files to said mass storage means;
said audio unit being adapted to be connected to an electrical power source disposed in said frame assembly; and
(d) at least one audio transducer proximate each ear of said user, said transducers being attached to said frame assembly and operably connected to said audio unit and adapted to receive said electrical audio output signal and convert it to a sound wave transmitted to said ear of said user.

28. Audio eyeglasses as recited by claim 27, wherein said interface means comprises a wired interface connection and an interface connector.

29. Audio eyeglasses as recited by claim 27, wherein said wired interface connection is selected from the group consisting of USB and IEEE 1394 connections.

30. Audio eyeglasses as recited by claim 27, wherein said interface means comprises a wireless interface connection.

31. Audio eyeglasses as recited by claim 27, wherein said mass storage means is adapted to store at least one gigabyte of said digital audio files.

32. Audio eyeglasses as recited by claim 27, wherein said mass storage means comprises at least one disk drive selected from the group consisting of magnetic, magnetooptical, and optical disk drives

33. Audio eyeglasses as recited by claim 27, wherein said mass storage means comprises a magnetic disk drive.

34. Audio eyeglasses as recited by claim 27, wherein said mass storage means further comprises flash memory.

35. Audio eyeglasses as recited by claim 27, wherein said mass storage means comprises a removable storage element.

36. Audio eyeglasses as recited by claim 27, further comprising at least one solar cell disposed at the surface of said frame assembly and connected to said audio unit.

37. A personal audio system, comprising:
(a) audio eyeglasses as recited by claim 27 and further comprising an audio system docking connector;
(b) a docking station having a computer docking connector adapted to mate with said audio system docking connector, said docking station being adapted to be connected to said data source; and
(c) said interface means comprises a connection to said data source established through said audio system and computer docking connectors.

38. Audio eyeglasses as recited by claim 1, wherein said control means comprises an alphanumeric display that indicates one or more of the time and date, battery charge status, a title or code indicative of the file or files selected for playback, the time length of a selection, the elapsed or remaining time during the playback of a selection, or other desirable information related to the operation of said audio unit.

39. Audio eyeglasses as recited by claim 38, wherein said alphanumeric display is a liquid crystal display.

40. Audio eyeglasses as recited by claim 27, wherein said control means comprises an alphanumeric display that indicates one or more of the time and date, battery charge status, a title or code indicative of the file or files selected for playback, the time length of a selection, the elapsed or remaining time during the playback of a selection, or other desirable information related to the operation of said audio unit.

41. Audio eyeglasses as recited by claim 40, wherein said alphanumeric display is a liquid crystal display.
